(19) United States
(12) Patent Application Publication
(10) Pub. No.: US 2026/0044907 A1
(43) Pub. Date: Feb. 12, 2026

(54) INFORMATION PROCESSING APPARATUS, HYDROGEN PRODUCTION SYSTEM, POWER SUPPLY SYSTEM, OPERATION PLAN CREATION METHOD, AND COMPUTER PROGRAM

(71) Applicants: ENEOS CORPORATION, Chiyoda, Tokyo (JP); NATIONAL INSTITUTE OF ADVANCED INDUSTRIAL SCIENCE AND TECHNOLOGY, Chiyoda-ku, Tokyo (JP)

(72) Inventors: Kosuke HARADA, Chiyoda-ku, Tokyo (JP); Hirofumi TAKAMI, Chiyoda-ku, Tokyo (JP); Ichiro OKUMO, Chiyoda-ku, Tokyo (JP); Kazuki UEHARA, Chiyoda-ku, Tokyo (JP); Hirokazu KOJIMA, Koriyama-shi, Fukushima (JP); Hiroshi KIKUSATO, Koriyama-shi Fukushima (JP); Takashi OOZEKI, Koriyama-shi Fukushima (JP); Hirohide FURUTANI, Koriyama-shi Fukushima (JP)

(73) Assignees: ENEOS CORPORATION, Chiyoda, Tokyo (JP); NATIONAL INSTITUTE OF ADVANCED INDUSTRIAL SCIENCE AND TECHNOLOGY, Chiyoda-ku, Tokyo (JP)

(21) Appl. No.: 18/998,319

(22) PCT Filed: Jul. 20, 2023
(86) PCT No.: PCT/JP2023/026653

§ 371 Date: Jan. 24, 2025

(30) Foreign Application Priority Data
Jul. 26, 2022 (JP) 2022118700

(51) Int. Cl. G06Q 50/06; C01B 3/02; H02J 3/28; H02J 3/38; H02J 15/00

(52) U.S. Cl. CPC G06Q 50/06; C01B 3/02; H02J 3/28; H02J 3/381; H02J 15/008; C01B 2203/16; H02J 2203/20; H02J 2300/24; H02J 2300/30

(57) ABSTRACT

A management server executes a first step of creating an operation plan for a hydrogen production facility in a first period in a future by solving a mathematical programming problem using an operation state of the hydrogen production facility for each time in the first period as a variable. The management server executes a second step of creating an operation plan for the hydrogen production facility in a second period that is a future period shorter than the first period by solving a mathematical programming problem using an operation state of the hydrogen production facility for each time in the second period as a variable. The management server executes the second step more frequently than the first step. The management server uses a part of the operation plan created in the first step as a constraint condition of the mathematical programming problem in the second step.

Buchanan

### TECHNICAL FIELD

The present disclosure relates to a data processing technology, and specifically relates to an information processing apparatus, a hydrogen production system, a power supply system, an operation plan creation method, and a computer program.

### BACKGROUND ART

Hydrogen production facilities that produce hydrogen by electrolyzing water and hydrogen production facilities that produce hydrogen by reforming hydrocarbon-based gas are known (see, for example, Patent Literature 1).

### PRIOR-ART LITERATURE

### Patent Literature

Patent Literature 1: JP 2021-046600 A

### SUMMARY OF INVENTION

### Technical Problem

Conventionally, an operation plan for a hydrogen production facility has been created according to hydrogen demand for each time and cost of energy (for example, electric power) to be used. As the target period for which the operation plan is created is longer, a long-term supply and demand trend can be reflected, and an operation plan desirable in the long term can be created. However, when a long-term operation plan is created, a calculation amount of a computer increases, and it may take a long time to create the operation plan.

The present disclosure has been made in view of such a circumstance, and one of the objects of the present disclosure is to provide a technology for achieving both creation of an operation plan for a hydrogen production facility desirable in the long term and suppression of the calculation amount.

### Solution to Problem

To solve the above problem, an information processing apparatus according to an aspect of the present disclosure includes a processor. The processor executes a first step of creating an operation plan for a hydrogen production facility in a first period in a future by solving a mathematical programming problem using an operation state of the hydrogen production facility for each time in the first period as a variable, and a second step of creating an operation plan for the hydrogen production facility in a second period that is a future period shorter than the first period by solving a mathematical programming problem using an operation state of the hydrogen production facility for each time in the second period as a variable, the processor executes the second step more frequently than the first step, and a part of the operation plan created in the first step is used as a constraint condition of the mathematical programming problem in the second step.

Another aspect of the present disclosure is a hydrogen production system. The hydrogen production system includes a hydrogen production facility and an information processing apparatus. The information processing apparatus executes a first step of creating an operation plan for a hydrogen production facility in a first period in a future by solving a mathematical programming problem using an operation state of the hydrogen production facility for each time in the first period as a variable, and a second step of creating an operation plan for the hydrogen production facility in a second period that is a future period shorter than the first period by solving a mathematical programming problem using an operation state of the hydrogen production facility for each time in the second period as a variable, the information processing apparatus executes the second step more frequently than the first step, and a part of the operation plan created in the first step is used as a constraint condition of the mathematical programming problem in the second step.

Still another aspect of the present disclosure is a power supply system. The power supply system is a power supply system that supplies power to a power grid using power obtained from a renewable energy power generator that generates power using renewable energy, the power supply system including a power conditioner device that adjusts power generated by the renewable energy power generator, a storage battery capable of storing and discharging at least a part of surplus power that is not supplied to the power grid among power adjusted by the power conditioner device, a hydrogen production facility that produces hydrogen by using at least a part of the surplus power that is not supplied to the power grid among the power adjusted by the power conditioner device, a hydrogen storage facility capable of storing and releasing hydrogen produced by the hydrogen production facility, a fuel cell that generates power using hydrogen released from the hydrogen storage facility, and control means that controls at least an operation of the hydrogen production facility. The control means execute a first step of creating an operation plan for the hydrogen production facility in a first period in a future by solving a mathematical programming problem using an operation state of the hydrogen production facility for each time in the first period as a variable, and a second step of creating an operation plan for the hydrogen production facility in a second period that is a future period shorter than the first period by solving a mathematical programming problem using an operation state of the hydrogen production facility for each time in the second period as a variable, the control means executes the second step more frequently than the first step, a part of the operation plan created in the first step is used as a constraint condition of the mathematical programming problem in the second step, and the control means controls the hydrogen production facility based on the operation plan created in the second step.

Yet still another aspect of the present disclosure is an operation plan creation method. In this method, a computer executes a first step of creating an operation plan for a hydrogen production facility in a first period in a future by solving a mathematical programming problem using an operation state of the hydrogen production facility for each time in the first period as a variable, and a second step of creating an operation plan for the hydrogen production facility in a second period that is a future period shorter than the first period by solving a mathematical programming problem using an operation state of the hydrogen production facility for each time in the second period as a variable, the computer executes the second step more frequently than the first step, and a part of the operation plan created in the first step is used as a constraint condition of the mathematical programming problem in the second step.

Any combinations of the above-described components and expressions of the present disclosure converted between a recording medium or the like recording a computer program are also effective as aspects of the present disclosure.

### Advantageous Effects of Invention

The technology of the present disclosure can achieve both creation of an operation plan for a hydrogen production facility desirable in the long term and suppression of the calculation amount.

### BRIEF DESCRIPTION OF DRAWINGS

FIG. 1 is a diagram illustrating a configuration of a hydrogen production system of First Example.

FIG. 2 is a diagram illustrating a plurality of constants used in creation of an operation plan.

FIG. 3 is a diagram illustrating a plurality of variables used in creation of an operation plan.

FIG. 4 is a diagram illustrating the estimation results of Examples, Modifications, and Comparative Examples.

FIG. 5 is a diagram illustrating a configuration of a power supply system of Second Example.

### DESCRIPTION OF EMBODIMENTS

A subject of an apparatus or method in the present disclosure includes a computer. The functions of the subject of the apparatus or method in the present disclosure is implemented by this computer executing a computer program. The computer includes a processor that operates according to a computer program as a main hardware configuration. The type of the processor is not limited as long as the function can be implemented by executing the computer program. The processor includes one or a plurality of electronic circuits including a semiconductor integrated circuit (IC, LSI, or the like). The computer program is recorded in a non-transitory recording medium such as a computer-readable ROM, an optical disk, or a hard disk drive. The computer program may be stored in advance in a recording medium, or may be supplied to the recording medium via a wide-area communication network including the Internet or the like.

Hereinafter, the technology of the present

disclosure will be described with reference to the drawings based on preferred Examples. The Examples are not intended to limit the invention, but are merely examples, and all the features described in Examples and combinations thereof are not necessarily essential to the invention. The same or equivalent components, members, and processing illustrated in the respective drawings are denoted by the same reference numerals, and redundant description will be omitted as appropriate. The scale and shape of each part illustrated in each drawing are set for convenience in order to facilitate the description, and are not limitedly interpreted unless otherwise specified. The terms “first”, “second”, and the like used in the present specification or claims do not represent any order or importance unless otherwise specified, and are intended to distinguish one configuration from another configuration.

First, an outline of Examples will be described. Conventionally, an operation plan for a hydrogen production facility (a water electrolysis apparatus, a steam reforming apparatus, or the like) or a hydrogen consumption facility (a fuel cell, a hydrogen gas turbine, or the like) has been determined according to hydrogen demand or power demand for each time, or a cost of energy (electric power, gas, hydrogen, or the like) as a raw material. Meanwhile, mathematical programming is known as a method for designing a future operation plan. Mathematical programming is a method of obtaining a variable (decision variable) that minimizes or maximizes an objective function while satisfying a predetermined constraint condition.

The period for which the operation plan is created is a future period after the time point of the operation plan creation, and is hereinafter also referred to as “planning target period”. As the planning target period is longer, a more accurate operation plan reflecting a long-term supply and demand trend. The long-term supply and demand trend includes, for example, variations in hydrogen demand, power demand, or the cost of energy as a raw material. Since predicted data is used as an input value for creating the operation plan, long-term predicted data is required for creating a long-term operation plan. However, long-term predicted data is not easily obtained. In addition, when a long-term operation plan is created, a calculation amount of a computer increases, it takes a long time to obtain a solution using the computer, and it may take a long time to create the operation plan.

Thus, the information processing apparatus (management server 40 to be described later) of Examples executes the operation plan creation for the hydrogen production facility in two steps. The information processing apparatus executes a first step for creating a relatively long-term operation plan at a relatively low frequency using available predicted data. The information processing apparatus executes a second step for creating a relatively short-term operation plan more frequently than the first step using a constraint condition (it can also be referred to as boundary condition) determined based on the operation plan created in the first step. This achieves both creation of an operation plan for a hydrogen production facility desirable in the long term reflecting a long-term supply and demand trend and suppression of the calculation amount.

It can be said that the operation plan for the hydrogen production facility is a plan in which the time-series electrolytic power, hydrogen production amount, operation amount, or the like of the hydrogen production facility is determined. For example, the operation plan for the hydrogen production facility may include a data group indicating electrolytic power, a hydrogen production amount, an operation amount, or the like for each unit time in the planning target period. Hereinafter, the relatively long-term operation plan created in the first step is also referred to as “long-term plan”, and the relatively short-term operation plan created in the second step is also referred to as “short-term plan”.

### First Example

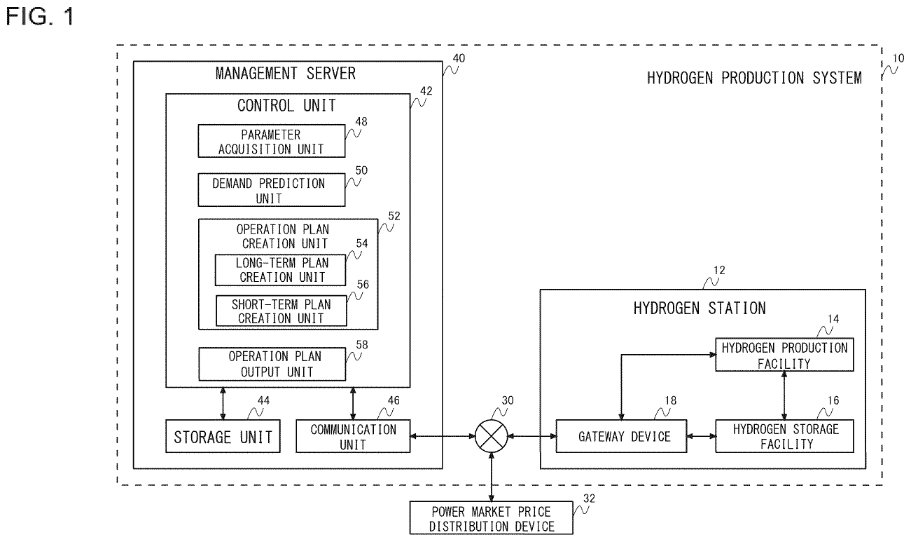

First Example will be described in detail. FIG. 1 illustrates a configuration of a hydrogen production system 10 of First Example. The hydrogen production system 10 includes a hydrogen station 12 and a management server 40.

The hydrogen station 12 is a service station that produces, stores, and supplies hydrogen to be used in equipment such as a fuel cell vehicle (hereinafter, also referred to as “FCV”).

The hydrogen station 12 includes a hydrogen production facility 14, a hydrogen storage facility 16, and a gateway device 18. The hydrogen production facility 14 includes a hydrogen generator (also referred to as water electrolysis apparatus or electrolysis tank) that produces hydrogen by electrolyzing water using electric power provided from a power grid. The hydrogen storage facility 16 includes a hydrogen tank that stores hydrogen produced by the hydrogen production facility 14. The gateway device 18 is a device that communicates with a device (in First Example, including the management server 40) outside the hydrogen station 12.

The management server 40 is an information processing apparatus that creates an operation plan for the hydrogen production facility 14. The management server 40 may create an operation plan for a plurality of hydrogen production facilities 14 installed in a plurality of hydrogen stations 12. The gateway device 18 of the hydrogen station 12 and the management server 40 are connected via a communication network 30 including a LAN, a WAN, and the Internet, and constitute an energy management system (EMS). In First Example, the creation of the operation plan for the hydrogen production facility 14 with the management server 40 is provided to the hydrogen station 12 as a cloud service.

As a modification, the function of creating an operation plan for the hydrogen production facility 14 (the function of the management server 40 in First Example) may be implemented in a device installed in the hydrogen station 12.

The management server 40 is also connected to a power market price distribution device 32 via the communication network 30. The power market price distribution device 32 provides actual data or predicted data of the power price in the power market to an external device (the management server 40 or the like). The power price in

First Example may vary for each unit time (30 minutes in First Example, and is hereinafter also referred to as a “frame”). The unit of the power price is, for example, yen/kWh (kilowatt-hour).

FIG. 1 includes a block diagram illustrating functional blocks of the management server 40. Each block illustrated in the block diagram of the present specification can be realized by a processor (CPU or the like) of a computer, an element including a memory, an electronic circuit, or a mechanical device in terms of hardware, and is realized by a computer program or the like in terms of software, but here, functional blocks realized by cooperation thereof are illustrated. Therefore, it is understood by the skilled person that these functional blocks can be realized in various forms by a combination of hardware and software.

The management server 40 includes a control unit 42, a storage unit 44, and a communication unit 46. The control unit 42 executes various data processing for creating an operation plan for the hydrogen production facility 14. The storage unit 44 includes one or both of a nonvolatile storage area and a volatile storage area, and stores data to be referred to or updated by the control unit 42. The communication unit 46 communicates with an external device in accordance with a predetermined communication protocol. The control unit 42 transmits and receives data to and from the gateway device 18 and the power market price distribution device 32 via the communication unit 46.

The storage unit 44 stores a plurality of constants used in the creation of the operation plan, in other words, a plurality of constants included in the objective function and the constraint condition used in the mathematical programming. The constant can be said to be a parameter whose value does not change in the optimization calculation of the objective function based on the mathematical programming. A value acquired from an external device, a past actual value, a design value, a predicted value, or an assumed value may be set to each constant.

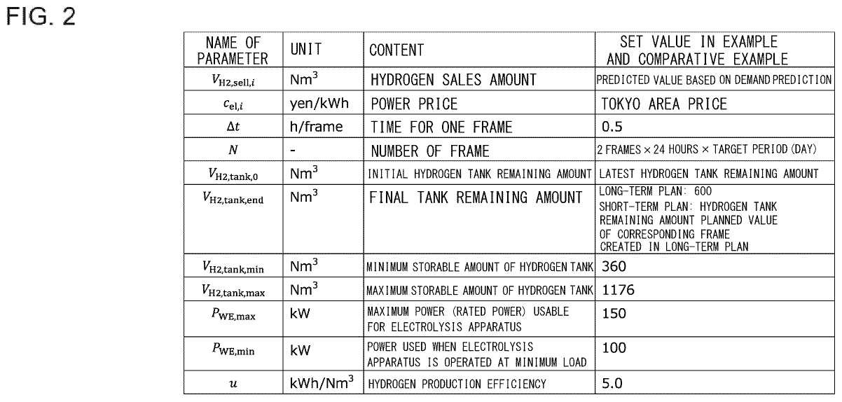

FIG. 2 illustrates a plurality of constants used in the creation of the operation plan. The index i of each constant represents a frame number. One frame is a unit time in creating the operation plan, and one frame in First Example is 30 minutes. In First Example, the planning target period has a length of, for example, about one day to seven days. The initial value of the index i is 0. The end value of the index i is the number of frames of the planning target period−1 (for example, 2 frames/hour×24 hours/day×planning target period (day)−1).

The hydrogen sales amount V_{H2,sell,i} can also be referred to as a hydrogen demand amount, and is a predicted value of the sales amount in each frame set based on the latest hydrogen demand prediction. The power price Cel,i is an actual contract price (for example, a market price in a wholesale electricity market) and a market price predicted value created by any method. A value of 2 frames/hour×24 hours×planning target period (day) is set as the number of frames N.

The initial hydrogen tank remaining amount V_{H2,tank,0} is the hydrogen remaining amount at the start of the planning target period stored in the hydrogen tank of the hydrogen storage facility 16 in any case of the long-term plan and the short-term plan. The final tank remaining amount V_{H2,tank,end} is the hydrogen remaining amount at the end of the planning target period stored in the hydrogen tank of the hydrogen storage facility 16. In the case of the long-term plan, a fixed value “600”, which is 50% of the maximum storable amount V_{H2,tank,max} of the hydrogen tank, is set as the final tank remaining amount V_{H2,tank,end}. On the other hand, in the case of the short-term plan, the value of the hydrogen tank remaining amount V_{H2,tank,i} of the frame corresponding to the time point at the end of the short-term plan calculated in the long-term plan is set as the final tank remaining amount V_{H2,tank,end}. As the final tank remaining amount V_{H2,tank,end}, a value other than 50% (600) of the maximum storable amount V_{H2,tank,max} of the hydrogen tank may be used, or a dynamically determined value may be used.

The storage unit 44 stores a plurality of variables used in the creation of the operation plan, for example, a plurality of variables included in the objective function and the constraint condition used in the mathematical programming. The variable can be said to be a parameter whose value is optimized by optimization calculation of an objective function based on the mathematical programming.

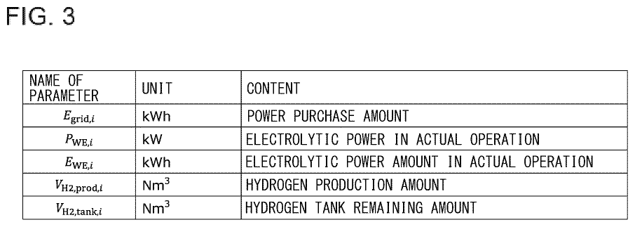

FIG. 3 illustrates the plurality of variables used in the creation of the operation plan. The index i of each variable is the same as the index i of the constant. The electrolytic power P_{WE,i} during actual operation of the hydrogen production facility 14 is a parameter indicating the operation state of the hydrogen production facility 14 in each frame of the planning target period. The electrolytic power P_{WE.i} can also be said as the power consumed by the hydrogen production facility 14 in each frame, and can also be said as the operation load factor or the operation amount of the hydrogen production facility 14 in each frame. The hydrogen tank remaining amount V_{H2,tank,i} is a parameter indicating the remaining amount of hydrogen stored in the hydrogen tank of the hydrogen storage facility 16 in each frame of the planning target period.

The description returns to FIG. 1. The control unit 42 includes a parameter acquisition unit 48, a demand prediction unit 50, an operation plan creation unit 52, and an operation plan output unit 58. The operation plan creation unit 52 includes the long-term plan creation unit 54 and the short-term plan creation unit 56. A computer program in which the functions of the plurality of functional blocks are implemented may be installed in a storage (the storage unit 44 or the like) of the management server 40. The control unit 42 may be realized by a processor (CPU or the like) of the management server 40. The processor of the management server 40 may perform the functions of the plurality of functional blocks by reading the computer program into the main memory and executing the computer program.

The parameter acquisition unit 48 acquires a value of a parameter (for example, a value of a constant parameter) used in the operation plan creation from an external device and stores the value in the storage unit 44. For example, the parameter acquisition unit 48 acquires data of the power price C_{el,i} (power price for each frame) used when creating the operation plan from the power market price distribution device 32. The parameter acquisition unit 48 periodically acquires the latest value of the hydrogen remaining amount stored in the hydrogen tank of the hydrogen storage facility 16 from the hydrogen station 12 (for example, the gateway device 18).

The demand prediction unit 50 predicts a hydrogen sales amount V_{H2,sell,i} for each frame in the planning target period and stores the data in the storage unit 44. The demand prediction unit 50 may predict the hydrogen sales amount in the planning target period based on the past hydrogen sales amount results, increase/decrease tendencies, weather information and traffic information regarding the planning target period, and the like. The demand prediction unit 50 may also estimate the hydrogen sales amount in the planning target period using a known prediction technology or estimation technology.

The operation plan creation unit 52 creates an operation plan for the hydrogen production facility 14 using a mathematical programming. The long-term plan creation unit 54 executes the first step of the operation plan creation and creates an operation plan having a relatively long planning target period (long-term plan). The short-term plan creation unit 56 executes the second step of the operation plan creation and creates an operation plan having a relatively short planning target period (short-term plan). In First Example, the planning target period in the long-term plan is seven days (the number of frames is 336), and the planning target period in the short-term plan is one day (the number of frames is 48).

The long-term plan creation unit 54 repeatedly creates the long-term plan at a low frequency. The short-term plan creation unit 56 repeatedly creates the short-term plan at a high frequency. In First Example, the creation frequency of the long-term plan is once every three hours, and the creation frequency of the short-term plan is once every hour. Within a range that satisfies a condition that the planning target period in the second step is shorter than the planning target period in the first step, and the plan creation frequency in the second step is higher than the plan creation frequency in the first step, the length of the planning target period, the plan creation frequency, and the time resolution (time per frame) of each of the first step and the second step may take any values.

Both the long-term plan creation unit 54 and the short-term plan creation unit 56 create an operation plan for the hydrogen production facility 14 by solving mathematical programming problems shown in the following Expressions 1 to 7.

Expression 1 represents an objective function f in the operation plan creation.

$$f = {\sum }_{i} ( {c}_{el , i} {E}_{g r i d , i} ) \qquad ( Expression 1 )$$

The objective function f indicates the power purchase cost for each frame for operating the hydrogen production facility 14, in other words, indicates the power procurement cost for hydrogen production.

The following Expression 2 to Expression 7 indicate constraint conditions in the operation plan creation.

$${E}_{grid , i} = {E}_{WE , i} = {P}_{WE , i} Δ t \qquad ( Expression 2 )$$

$${V}_{H 2 , prod , i} = u \cdot {E}_{W E , i} \qquad ( Expression 3 )$$

$${V}_{H 2 , t a n k , i} = {V}_{H 2 , t a n k , 0} + {\sum }_{j = 0}^{i} ( {V}_{H 2 , p r o d , j} - {V}_{H 2 , sell , j} ) \qquad ( Expression 4 )$$

$${V}_{H 2 , t a n k , N - 1} = {V}_{H 2 , t a n k , e n d} \qquad ( Expression 5 )$$

$${V}_{H 2 , tank , min} \leq {V}_{H 2 , tank , i} \leq {V}_{H 2 , tank , max} \qquad ( Expression 6 )$$

$$0 \leq {P}_{WE , i} \leq {P}_{WE , max} \qquad ( Expression 7 )$$

Expression 2 indicates a constraint in which the power purchase amount E_{grid,i} from the power grid per frame matches the electrolytic power amount E_{WE,i} of the hydrogen production facility 14 and is 0.5 times the electrolytic power P_{WE,i} of the hydrogen production facility 14. Expression 3 indicates a constraint on the relationship between a hydrogen production amount V_{H2,prod,i} and the electrolytic power amount E_{WE,i} of the hydrogen production facility 14. Expressions 4 to 6 indicates constraints on the hydrogen remaining amount in the hydrogen storage facility 16 (hydrogen tank). Expression 7 is a constraint on the value range of the electrolytic power P_{WE,i} of the hydrogen production facility 14.

Expression 4 and Expression 6 define that the hydrogen production amount satisfies the hydrogen sales amount. Expression 4 defines that the hydrogen remaining amount in the hydrogen storage facility 16 is the sum of an increase due to past hydrogen production and a decrease due to hydrogen supply to the FCV or the like. Expression 6 defines that the hydrogen remaining amount in the hydrogen storage facility 16 is not below the minimum storage amount and not above the maximum storage mount. The minimum storage amount is, for example, the minimum amount of hydrogen to be stored in order to satisfy the hydrogen sales amount. The maximum storage amount is, for example, the capacity of the hydrogen tank. Alternatively, an amount provided with a margin may be set as the minimum storage amount or the maximum storage amount.

Expression 5 defines that the hydrogen remaining amount when one operation plan ends (that is, when the index i of the frame number reaches the final value) becomes a specified valued (here, the final tank remaining amount V_{H2,tank,end}). When Expression 5 is not provided, an operation plan is created such that the final tank remaining amount becomes zero when the objective function is optimized. However, when the tank remaining amount becomes zero, hydrogen cannot be supplied to the FCV. Providing Expression 5 makes it possible to create an optimal operation plan while leaving only the specified amount of the final tank remaining amount.

In First Example, the long-term plan creation unit 54 and the short-term plan creation unit 56 use mathematical programming (for example, mixed-integer linear programming) to derive the power purchase amount E_{grid,i} of each frame that minimizes the objective function f of Expression 1 (that is, the power procurement cost for hydrogen production) under the constraint conditions shown in Expressions 2 to 7 based on the parameter values stored in the storage unit 44. The electrolytic power P_{WE,i} of the hydrogen production facility 14 corresponding to the derived power purchase amount E_{grid,i} is derived based on Expression 2. The operation plan for the hydrogen production facility 14 includes at least the electrolytic power P_{WE,i}. A known technology may be used for obtaining a solution using mathematical programming.

The short-term plan creation unit 56 uses a part of the long-term plan created by the long-term plan creation unit 54 as a constraint condition of the mathematical programming problem at the time of creating the short-term plan. In First Example, the short-term plan creation unit 56 uses the hydrogen remaining amount at the same time in the planning target period of the long-term plan created by the long-term plan creation unit 54 (that is, at the end of the planning target period of the short-term plan) as the hydrogen remaining amount at the end of the planning target period for creating the short-term plan.

Specifically, the short-term plan creation unit 56 uses the hydrogen tank remaining amount V_{H2,tank,i} of the same frame as that at the end of the planning target period of the short-term plan among the hydrogen tank remaining amounts V_{H2,tank,i} of the frames indicated by the latest long-term plan created by the long-term plan creation unit 54 as the final tank remaining amount V_{H2,tank,end} under the constraint condition of Expression 5. The result of the long-term plan based on the long-term supply and demand trend is thus reflected in the short-term plan. The long-term plan creation unit 54 uses a fixed value “600” as V_{H2,tank,end} of the constraint condition of Expression 5. The fixed value “600” is about a half of the maximum storable amount V_{H2,tank,max} of the hydrogen tank.

The description returns to FIG. 1. The operation plan output unit 58 provides data related to the operation plan (short-term plan) created by the short-term plan creation unit 56 (hereinafter, the data is also referred to as “operation plan data”) to a device on the hydrogen production facility 14 side (in Examples, the gateway device 18 of the hydrogen station 12). In First Example, the operation plan data may include the power purchase amount E_{grid,i} and the electrolytic power P_{WE,i} of the hydrogen production facility 14 in the latest frame (for example, the next frame of the current time point) indicated by the latest short-term plan. As a modification, the operation plan data may include the power purchase amount E_{grid,i} and the electrolytic power P_{WE,i} of the hydrogen production facility 14 in each future frame.

An operation of the hydrogen production system 10 having the above configuration will be described.

The parameter acquisition unit 48 of the management server 40 acquires values of various parameters necessary for creating an operation plan for the hydrogen production facility 14 from an external device and stores the values in the storage unit 44. For example, the parameter acquisition unit 48 periodically and repeatedly acquires data of the current power price and the predicted value of the future power price from the power market price distribution device 32. The parameter acquisition unit 48 also periodically and repeatedly acquires data of the current hydrogen remaining amount in the hydrogen storage facility 16 via the gateway device 18. The demand prediction unit 50 of the management server 40 predicts the future hydrogen sales amount V_{H2,sell,i} (in other words, the hydrogen sales amount in the planning target period), and stores the value of the prediction result in the storage unit 44.

The long-term plan creation unit 54 of the management server 40 inputs the values of the plurality of parameters stored in the storage unit 44 (predicted value and the like) to the objective function of Expression 1 and the constraint conditions of Expressions 2 to 7, and derives the value of a decision variable (for example, power purchase amount E_{grid,i} electrolytic power P_{WE,i}, hydrogen tank remaining amount V_{H2,tank,i}, or the like) that minimizes the objective function using the mathematical programming. The long-term plan creation unit 54 derives the value of the decision variable of each frame for seven days as the long-term plan data for seven days using the predicted values (for example, hydrogen sales amount V_{H2,sell,i}, power price C_{el,i}, or the like) for seven days of the plurality of parameters. The long-term plan creation unit 54 creates long-term plan data once every three hours. The long-term plan creation unit 54 stores the created long-term plan data in the storage unit 44.

The short-term plan creation unit 56 of the management server 40 inputs the values of the plurality of parameters stored in the storage unit 44 to the objective function of Expression 1 and the constraint conditions of Expressions 2 to 7, and derives the value of a decision variable (for example, power purchase amount E_{grid,i} electrolytic power P_{WE,i}, or the like) that minimizes the objective function using the mathematical programming. The short-term plan creation unit 56 derives the value of the decision variable of each frame for one day as the short-term plan data for one day using the predicted values for one day of the plurality of parameters. The short-term plan creation unit 56 creates short-term plan data once every hour. The short-term plan creation unit 56 uses the hydrogen tank remaining amount V_{H2,tank,i} of the frame corresponding to the time point at the end of the planning target period among the long-term plan data stored in the storage unit 44 as V_{H2,tank,end} of the constraint condition of Expression 5. The short-term plan creation unit 56 stores the created short-term plan data in the storage unit 44.

The operation plan output unit 58 of the management server 40 transmits the operation plan data for the hydrogen production facility 14 based on the short-term plan created by the short-term plan creation unit 56 and stored in the storage unit 44 to the gateway device 18 of the hydrogen station 12. For example, the operation plan output unit 58 may periodically and repeatedly transmit the values of the power purchase amount and the electrolytic power of the latest frame among the values of the decision variables of the frames indicated by the latest short-term plan created by the short-term plan creation unit 56 to the gateway device 18. In the hydrogen station 12, the power purchase from the power grid and the operation of the hydrogen production facility 14 are controlled according to the operation plan data transmitted from the management server 40, and hydrogen is produced.

Hereinafter, the estimation results with the operation plan creation method of Examples and the operation plan creation method of Comparative Examples will be described. In this estimation, the creation of the long-term plan and the short-term plan was repeated for 30 days, and the cost per unit hydrogen production amount when the hydrogen production facility 14 was controlled as planned was estimated. In this estimation, a past contract price (Tokyo area price from Mar. 1, 2022 to Mar. 31, 2022) was used as the power price. A demand curve was created assuming that the number of FCVs visiting the hydrogen station 12 was five per day, and a hydrogen sales amount for each frame was set.

As described above, in Examples, the planning target period of the long-term plan was set to seven days, and the planning target period of the short-term plan was set to one day. Here, as First Modification, an estimation was also performed by the operation plan creation method in which the planning target period of the long-term plan was five days, and the planning target period of the short-term plan was one day. As Second Modification, an estimation was also performed by the operation plan creation method in which the planning target period of the long-term plan was three days, and the planning target period of the short-term plan was one day. The frequency of creating the operation plan in First Modification and Second Modification is the same as that in Examples (once every three hours for long-term plan and once every hour for short-term plan).

On the other hand, in First Comparative Example and Second Comparative Example, the two-stage operation plan creation is not performed. Specifically, a low-frequency (once every three hours) first step is not performed, and only a high-frequency (once every hour) second step is performed. The planning target period in First Comparative Example is one day, and the planning target period in Second Comparative Example is seven days.

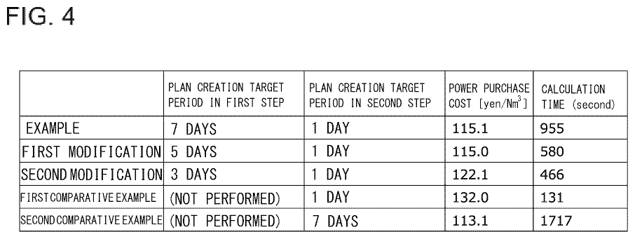

FIG. 4 is a diagram illustrating the estimation results of Examples, Modifications, and Comparative Examples. The power purchase cost is a value obtained by dividing the sum of the products of the power consumption and the power unit price of each frame for 30 days by the sum of the hydrogen production amounts V_{H2,prod,i} for 30 days when the hydrogen production facility 14 is operated according to the operation plan created last time for each frame for 30 days. The calculation time is a time required to create an operation plan (in Examples, First Modification, and Second Modification, the first step and the second step, and in First Comparative Example and Second Comparative Example, only the second step) for 30 days.

In Second Comparative Example, since the long-term operation plan is repeatedly created at a high frequency, an efficient operation plan (for example, the power purchase amount E_{grid,i} and the electrolytic power P_{WE,i}) having a small power purchase cost was obtained. On the other hand, in Second Comparative Example, the calculation amount was increased, and the calculation time was maximized. In First Comparative Example, since the short-term operation plan is repeatedly created at a high frequency, the calculation time was minimized. On the other hand, in First Comparative Example, an inefficient operation plan having a large power purchase cost was created.

In Examples, since a short-term operation plan is created in consideration of long-term variations such as power prices, the power purchase cost can be reduced as compared with First Comparative Example, and the calculation time can be shortened as compared with Second Comparative Example. Also in First Modification, the same power purchase cost and calculation time as in Examples was able to be realized. In Second Modification, although the power purchase cost is increased as compared with Examples, the calculation time can be shortened. In any of Examples, First

Modification, and Second Modification, it can be said that an efficient operation plan was created from the viewpoint of the power purchase cost.

According to the hydrogen production system 10 (management server 40) of First Example, it is possible to create an operation plan for the hydrogen production facility 14 which is desirable in the long term (from the viewpoint of supply and demand variation in the planning target period of the long-term plan), and it is possible to suppress the calculation amount in the creation. This makes it possible to improve the overall economic efficiency of the hydrogen production system 10. As illustrated in FIG. 4, the planning target period of the long-term plan as the first step may be three days to seven days in which the power purchase cost and the calculation time in the hydrogen production system 10 fall within an appropriate range. The lengths of the planning target periods of the first step and the second step may be freely selected according to the requirements of the business operator.

The present disclosure has been described above based on First Example. It is to be understood by the skilled person that First Example is an example, various modifications can be made to the combination of each component or each processing process, and such modifications are also within the scope of the present disclosure.

For example, in First Example, the hydrogen tank remaining amount V_{H2,tank,i} indicated by the long-term plan created in the first step is used as a constraint condition (final hydrogen tank remaining amount V_{H2,tank,end}) of the mathematical programming problem in the second step. As a modification, another variable value indicated by the long-term plan created in the first step may be used as a constraint condition (constant) of the mathematical programming problem in the second step. Another variable value may be, for example, the hydrogen production amount V_{H2,prod,i}. As a constraint condition (initial hydrogen tank remaining amount V_{H2,tank,0}) of the mathematical programming problem in the second step, the hydrogen tank remaining amount V_{H2,tank,i} of the frame corresponding to the time point at the start of the planning target period of the second step indicated by the long-term plan created in the first step may be used. Further, as a plurality of constraint conditions (final hydrogen tank remaining amount V_{H2,tank,end} and initial hydrogen tank remaining amount V_{H2,tank,0}) of the mathematical programming problem in the second step, the hydrogen tank remaining amount V_{H2,tank,i} indicated by the long-term plan created in the first step may be used.

Although not mentioned in First Example described above, when the hydrogen sales price varies depending on the time zone, the sum of the products of the hydrogen sales price and the hydrogen production amount for each time may be included in the objective function. In addition, the constraint conditions used in First Example are not necessarily used, and constraint conditions other than the constraint conditions used in First Example may be used. For example, when hydrogen is not produced outside business hours, a constraint condition that the hydrogen production amount outside business hours is 0 may be included.

In addition, in First Example described above, the hydrogen production facility 14 is provided in the hydrogen station 12, but as a modification, the hydrogen production facility 14 may be provided in a hydrogen supply facility for a fuel cell, chemical synthesis, or the like. The hydrogen production facility 14 may be provided in an energy (electric power, heat, hydrogen, and the like) supply system, and the energy supply system may include a storage battery, a fuel cell, and the like together with the hydrogen production facility 14.

In First Example described above, the operation plan output unit 58 of the management server 40 transmits the operation plan data to the hydrogen station 12 (gateway device 18). As a modification, the operation plan output unit 58 may store the operation plan data in a predetermined local or remote storage area. The operation plan output unit 58 may output the operation plan data to a predetermined display device and cause the display device to display the operation plan.

The parameter acquisition unit 48 of the management server 40 may acquire values of parameters for creating the operation plans for a plurality of hydrogen production facilities 14 from an external device. The storage unit 44 of the management server 40 may store the values of the parameters for creating operation plans for the plurality of hydrogen production facilities 14. The plurality of hydrogen production facilities 14 may be intensively installed in one hydrogen station 12 or may be dispersedly installed in a plurality of hydrogen stations 12. The operation plan creation unit 52 of the management server 40 may create the operation plan for each of the plurality of hydrogen production facilities 14 in parallel or sequentially using the operation plan creating method of the above Examples. The operation plan output unit 58 of the management server 40 may transmit data including the operation plan for each of the plurality of hydrogen production facilities 14 to the gateway device 18 of the hydrogen station 12 in which each hydrogen production facility 14 is installed.

Although not mentioned in First Example, in the hydrogen station 12, a device (here, it is referred to as “instruction device”) that instructs the hydrogen production facility 14 to produce hydrogen based on the data including the operation plan transmitted from the hydrogen production facility 14 may be installed. For example, the instruction device may control the operation of the hydrogen production facility 14 according to the electrolytic power PWE, i of the hydrogen production facility 14 of each frame indicated by the operation plan. The gateway device 18 of the hydrogen station 12 may include a function of the instruction device. In addition, the hydrogen production facility 14 may produce hydrogen based on instruction data from the instruction device, and may vary the hydrogen production amount for each frame.

### Second Example

Second Example of the present disclosure will be described focusing on differences from First Example, and description of common points will be appropriately omitted. It goes without saying that the features of Second Example can be freely combined with the features of First Examples and modifications. Among the components of Second Example, components that are the same as or correspond to the components of First Example will be appropriately denoted by the same reference numerals and described.

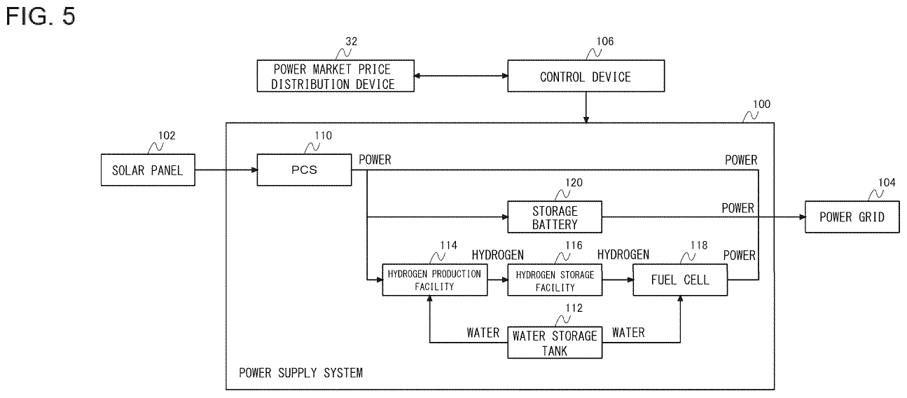

In Second Example, the technical idea described in First Example is applied to a power supply system including a hydrogen production facility. FIG. 5 is a diagram illustrating a configuration of a power supply system 100 of Second Example. The power supply system 100 is a self-sustaining power supply system that supplies power to a power grid 104 using power from a renewable energy power generator that generates power using renewable energy, for example, a solar power generator (solar panel 102) that generates power using sunlight. The power grid 104 is a system owned by a general power transmission and distribution company, and is a system that integrates power generation, transformation, power transmission, and power distribution for supplying power to a power receiving facility of a consumer.

The power supply system 100 includes a power conditioner device 110 (hereinafter, referred to as “PCS 110”), a water storage tank 112, a hydrogen production facility 114, a hydrogen storage facility 116, a fuel cell 118, a storage battery 120, and a control device 106. In the example of FIG. 5, the control device 106 is disposed outside the power supply system 100, but the present disclosure is not limited to this example. The control device 106 may be configured as a part of the power supply system 100.

The solar panel 102 includes a solar cell and constitutes a solar power generator that generates electric power by receiving sunlight at the solar cell and performing photoelectric conversion. Although the solar panel 102 is illustrated in FIG. 5, another power generator may be adopted as long as the power generator generates electric power using renewable energy. For example, a wind power generator that generates electric power from wind power may be adopted. A hydraulic power generator that generates electric power from hydraulic power may also be adopted. A geothermal power generator, a wave power generator, a temperature difference power generator, or a biomass power generator may be adopted. Further, a combination of power generators that generate electric power using these renewable energies may be adopted.

The PCS 110 adjusts the power generated by the solar panel 102. Here, the PCS 110 converts the power from the solar panel 102 into power that can be supplied to the power grid 104.

The water storage tank 112 stores water and supplies the stored water to the hydrogen production facility 114 and the fuel cell 118. In the example of FIG. 5, the water storage tank 112 is disposed inside the power supply system 100, but the present disclosure is not limited to this example. The water storage tank 112 may be provided outside the power supply system 100. As a modification, the power supply system 100 may supply water directly from the outside (for example, a water pipe) to the hydrogen production facility 114 and the fuel cell 118.

The hydrogen production facility 114 corresponds to the hydrogen production facility 14 of First Example. The hydrogen production facility 114 produces hydrogen by using at least a part of surplus power that is not supplied to the power grid 104 among the power adjusted by the PCS 110. Specifically, under the control of the control device 106, the hydrogen production facility 114 produces hydrogen by electrolyzing water supplied from the water storage tank 112 using electric power generated by the solar panel 102 and then adjusted by the PCS 110. In addition, the hydrogen production facility 114 includes a measuring instrument (not illustrated) such as a gas sensor, a pressure gauge, or a flow meter, and data measured by the measuring instrument is output to the control device 106 as a data signal.

The hydrogen storage facility 116 corresponds to the hydrogen storage facility 16 of First Example. As the hydrogen storage facility 116, a known facility capable of storing and releasing hydrogen can be adopted. For example, the hydrogen storage facility 116 includes a hydrogen absorbing alloy excellent in absorbing and releasing hydrogen, and stores and releases hydrogen produced by the hydrogen production facility 114 under the control of the control device 106. In addition, the hydrogen storage facility 116 includes a measuring instrument (not illustrated) such as a gas sensor, a pressure gauge, or a flow meter, and data measured by the measuring instrument is output to the control device 106 as a data signal.

Under the control of the control device 106, the fuel cell 118 generates power using hydrogen discharged from the hydrogen storage facility 116 and generates hot water using water supplied from the water storage tank 112 and exhaust heat. The power generated through the power generation of the fuel cell 118 is supplied to the power grid 104. The fuel cell 118 includes a measuring instrument (not illustrated) such as a gas sensor, a pressure gauge, or a flow meter, and a measuring instrument (not illustrated) that measures a reserved amount of hydrogen, and data measured by the measuring instrument is output to the control device 106 as a data signal.

The storage battery 120 stores at least a part of surplus power not supplied to the power grid 104 in the power adjusted by the PCS 110 and discharges the stored power. Specifically, the storage battery 120 stores the power generated by the solar panel 102 and adjusted by the PCS 110 under the control of the control device 106. The power stored in the storage battery 120 can be supplied to the power grid 104 by being discharged under the control of the control device 106. The storage battery 120 includes a measuring instrument (not illustrated) that measures the storage amount, and data measured by the measuring instrument is output to the control device 106 as a data signal.

The control device 106 is realized as, for example, an energy management system (EMS), and is configured as control means that controls each unit constituting the power supply system 100. The control device 106 includes an arithmetic unit (also referred to as processor, not illustrated) and a memory (not illustrated), and controls each unit with the arithmetic unit performing arithmetic processing using a program stored in the memory device. For example, the control device 106 performs control on the production amount of hydrogen in the hydrogen production facility 114, the storage amount/release amount of hydrogen in the hydrogen storage facility 116, the power generation amount in the fuel cell 118, the storage amount/discharge amount in the storage battery 120, and the like as control targets based on various types of information obtained from the outside or the inside of the power supply system 100.

The control device 106 is connected to the power market price distribution device 32 via the communication network. The control device 106 has a function of the management server 40 of First Example. For example, like the management server 40 of First Example, the control device 106 may include the parameter acquisition unit 48, the demand prediction unit 50, the operation plan creation unit 52 (long-term plan creation unit 54 and short-term plan creation unit 56), and the operation plan output unit 58 (not illustrated).

Like the management server 40 of First Example, the control device 106 creates a long-term operation plan for the hydrogen production facility 114 at a low frequency and creates a short-term operation plan for the hydrogen production facility 114 at a high frequency using a part of the content of the long-term operation plan. In the creation of the operation plan, the configuration described in First Example and a modification thereof can be applied. The control device 106 controls the hydrogen production facility 114 based on the created operation plan, like the instruction device of the above-described modification.

According to the power supply system 100 (control device 106) of Second Example, it is possible to create an operation plan for the hydrogen production facility 114 which is desirable in the long term (from the viewpoint of supply and demand variation in the planning target period of the long-term plan), and it is also possible to suppress the calculation amount in the creation. This makes it possible to improve the overall economic efficiency related to hydrogen production and power supply.

The present disclosure has been described above based on Second Example. It is to be understood by the skilled person that Second Example is an example, various modifications can be made to the combination of each component or each processing process, and such modifications are also within the scope of the present disclosure.

Any combination of the above-described examples and modifications is also useful as an embodiment of the present disclosure. A new embodiment generated by the combination has the effect of each of the combined examples and modifications. In addition, it is understood by the skilled person that the functions to be performed by the components described in the claims are realized by a single body of each component described in examples and the modifications or by cooperation of the components.

The technical idea described in Examples and Modifications described above can be expressed as aspects described in the following items.

### Item 1

An information processing apparatus (40) including a processor (42), wherein
the processor (42) executes:
a first step (54) of creating an operation plan for a hydrogen production facility (14) in a first period in a future by solving a mathematical programming problem using an operation state of the hydrogen production facility (14) for each time in the first period as a variable; and
a second step (56) of creating an operation plan for the hydrogen production facility (14) in a second period that is a future period shorter than the first period by solving a mathematical programming problem using an operation state of the hydrogen production facility (14) for each time in the second period as a variable,
the processor (42) executes the second step (56) more frequently than the first step (54), and
a part of the operation plan created in the first step (54) is used as a constraint condition of the mathematical programming problem in the second step (56).

This information processing apparatus can achieve both creation of an operation plan for a hydrogen production facility desirable in the long term and suppression of the calculation amount.

### Item 2

The information processing apparatus (40) according to item 1, wherein
a hydrogen remaining amount at a same time in the first period obtained in the first step (54) is used as a hydrogen remaining amount at an end of the second period in the constraint condition of the mathematical programming problem in the second step (56).

This aspect can effectively reflect the long-term plan created in the first step in the short-term plan created in the second step.

### Item 3

The information processing apparatus (40) according to item 1 or 2, wherein
the processor (42) further executes a step (58) of providing data related to the operation plan created in the second step (56) to an external device, and
the processor (42) further performs a step of providing the data related to the operation plan created in the second step (56) to a device on the hydrogen production facility (14) side.

This aspect can operate the hydrogen production facility based on the short-term plan of the second step reflecting the long-term plan of the first step, which is a short-term plan created at a high frequency, and can improve the economic efficiency related to the operation of the hydrogen production facility.

### Item 4

A hydrogen production system (10) including:
a hydrogen production facility (14); and
an information processing apparatus (40), wherein
the information processing apparatus (40) executes:
a first step (54) of creating an operation plan for a hydrogen production facility (14) in a first period in a future by solving a mathematical programming problem using an operation state of the hydrogen production facility (14) for each time in the first period as a variable; and
a second step (56) of creating an operation plan for the hydrogen production facility (14) in a second period that is a future period shorter than the first period by solving a mathematical programming problem using an operation state of the hydrogen production facility (14) for each time in the second period as a variable,
the information processing apparatus (40) executes the second step (56) more frequently than the first step (54), and
a part of the operation plan created in the first step (54) is used as a constraint condition of the mathematical programming problem in the second step (56).

This hydrogen production system can achieve both creation of an operation plan for a hydrogen production facility desirable in the long term and suppression of the calculation amount.

### Item 5

The hydrogen production system (10) according to item 4, further including
an instruction device structured to instruct the hydrogen production facility (14) to produce hydrogen based on data related to the operation plan created in the second step (56), the data being provided from the information processing apparatus (40).

This aspect can operate the hydrogen production facility based on the short-term plan of the second step reflecting the long-term plan of the first step, which is a short-term plan created at a high frequency, and can improve the economic efficiency related to the operation of the hydrogen production facility.

### Item 6

A power supply system (100) that supplies power to a power grid (104) using power obtained from a renewable energy power generator (102) that generates power using renewable energy, the power supply system (100) including:
a power conditioner device (110) structured to adjust power generated by the renewable energy power generator (102);
a storage battery (120) capable of storing and discharging at least a part of surplus power that is not supplied to the power grid (104) among power adjusted by the power conditioner device (110);
a hydrogen production facility (114) structured to produce hydrogen by using at least a part of the surplus power that is not supplied to the power grid (104) among the power adjusted by the power conditioner device (110);
a hydrogen storage facility (116) capable of storing and releasing hydrogen produced by the hydrogen production facility (114);
a fuel cell (118) structured to generate power using hydrogen released from the hydrogen storage facility (116); and
a control means (106) structured to control at least an operation of the hydrogen production facility (114), wherein
the control means (106) execute:
a first step (54) of creating an operation plan for the hydrogen production facility (116) in a first period in a future by solving a mathematical programming problem using an operation state of the hydrogen production facility (116) for each time in the first period as a variable; and
a second step (56) of creating an operation plan for the hydrogen production facility (116) in a second period that is a future period shorter than the first period by solving a mathematical programming problem using an operation state of the hydrogen production facility (116) for each time in the second period as a variable,
the control means (106) executes the second step (56) more frequently than the first step (54),
a part of the operation plan created in the first step (54) is used as a constraint condition of the mathematical programming problem in the second step (56), and
the control means (106) controls the hydrogen production facility (116) based on the operation plan created in the second step (56).

This power supply system can achieve both creation of an operation plan for a hydrogen production facility desirable in the long term and suppression of the calculation amount. In addition, by operating the hydrogen production facility based on an operation plan desirable in the long term, the economic efficiency related to the operation of the hydrogen production facility can be improved.

### Item 7

An operation plan creation method, wherein
a computer (40) executes:
a first step of creating an operation plan for a hydrogen production facility (14) in a first period in a future by solving a mathematical programming problem using an operation state of the hydrogen production facility (14) for each time in the first period as a variable; and
a second step of creating an operation plan for the hydrogen production facility (14) in a second period that is a future period shorter than the first period by solving a mathematical programming problem using an operation state of the hydrogen production facility (14) for each time in the second period as a variable,
the computer (40) executes the second step (56) more frequently than the first step (54), and
a part of the operation plan created in the first step (54) is used as a constraint condition of the mathematical programming problem in the second step (56).

This operation plan creation method can achieve both creation of an operation plan for a hydrogen production facility desirable in the long term and suppression of the calculation amount.

### Item 8

A computer program that causes a computer (40) to execute:
a first step (54) of creating an operation plan for a hydrogen production facility (14) in a first period in a future by solving a mathematical programming problem using an operation state of the hydrogen production facility (14) for each time in the first period as a variable; and
a second step (56) of creating an operation plan for the hydrogen production facility (14) in a second period that is a future period shorter than the first period by solving a mathematical programming problem using an operation state of the hydrogen production facility (14) for each time in the second period as a variable, wherein
the second step (56) is executed more frequently than the first step (54), and
a part of the operation plan created in the first step (54) is used as a constraint condition of the mathematical programming problem in the second step (56).

This computer program can achieve both creation of an operation plan for a hydrogen production facility desirable in the long term and suppression of the calculation amount.

### INDUSTRIAL APPLICABILITY

The technology of the present disclosure can be applied to an information processing apparatus and an information processing system.

### REFERENCE SIGNS LIST

10 hydrogen production system, 14 hydrogen production facility, 40 management server, 44 storage unit, 48 parameter acquisition unit, 50 demand prediction unit, 52 operation plan creation unit, 54 long-term plan creation unit, 56 short-term plan creation unit, 58 operation plan output unit, 100 power supply system, 102 solar panel, 104 power grid, 106 control device, 110 PCS, 114 hydrogen production facility, 116 hydrogen storage facility, 118 fuel cell, 120 storage battery

1. An information processing apparatus comprising a processor, wherein
the processor executes:
a first step of creating an operation plan for a hydrogen production facility in a first period in a future by solving a mathematical programming problem using an operation state of the hydrogen production facility for each time in the first period as a variable; and
a second step of creating an operation plan for the hydrogen production facility in
a second period that is a future period shorter than the first period by solving a mathematical programming problem using an operation state of the hydrogen production facility for each time in the second period as a variable,
the processor executes the second step more frequently than the first step, and
a part of the operation plan created in the first step is used as a constraint condition of the mathematical programming problem in the second step.

2. The information processing apparatus according to claim 1, wherein
a hydrogen remaining amount at a same time in the first period obtained in the first step is used as a hydrogen remaining amount at an end of the second period as the constraint condition of the mathematical programming problem in the second step.

3. The information processing apparatus according to claim 1, wherein
the processor further executes a step of providing data related to the operation plan created in the second step to a device on the hydrogen production facility side.

4. A hydrogen production system comprising:
a hydrogen production facility; and
an information processing apparatus, wherein
the information processing apparatus executes:
a first step of creating an operation plan for a hydrogen production facility in a first period in a future by solving a mathematical programming problem using an operation state of the hydrogen production facility for each time in the first period as a variable; and
a second step of creating an operation plan for the hydrogen production facility in a second period that is a future period shorter than the first period by solving a mathematical programming problem using an operation state of the hydrogen production facility for each time in the second period as a variable,
the information processing apparatus executes the second step more frequently than the first step, and
a part of the operation plan created in the first step is used as a constraint condition of the mathematical programming problem in the second step.

5. The hydrogen production system according to claim 4, further comprising
an instruction device structured to instruct the hydrogen production facility to produce hydrogen based on data related to the operation plan created in the second step, the data being provided from the information processing apparatus.

6. A power supply system that supplies power to a power grid using power obtained from a renewable energy power generator that generates power using renewable energy, the power supply system comprising:
a power conditioner device structured to adjust power generated by the renewable energy power generator;
a storage battery capable of storing and discharging at least a part of surplus power that is not supplied to the power grid among power adjusted by the power conditioner device;
a hydrogen production facility structured to produce hydrogen by using at least a part of the surplus power that is not supplied to the power grid among the power adjusted by the power conditioner device;
a hydrogen storage facility capable of storing and releasing hydrogen produced by the hydrogen production facility;
a fuel cell structured to generate power using hydrogen released from the hydrogen storage facility; and
a control means structured to control at least an operation of the hydrogen production facility, wherein the control means execute:
a first step of creating an operation plan for the hydrogen production facility in a first period in a future by solving a mathematical programming problem using an operation state of the hydrogen production facility for each time in the first period as a variable; and
a second step of creating an operation plan for the hydrogen production facility in a second period that is a future period shorter than the first period by solving a mathematical programming problem using an operation state of the hydrogen production facility for each time in the second period as a variable,
the control means executes the second step more frequently than the first step,
a part of the operation plan created in the first step is used as a constraint condition of the mathematical programming problem in the second step, and
the control means controls the hydrogen production facility based on the operation plan created in the second step.

7. An operation plan creation method, wherein
a computer executes:
a first step of creating an operation plan for a hydrogen production facility in a first period in a future by solving a mathematical programming problem using an operation state of the hydrogen production facility for each time in the first period as a variable; and
a second step of creating an operation plan for the hydrogen production facility in a second period that is a future period shorter than the first period by solving a mathematical programming problem using an operation state of the hydrogen production facility for each time in the second period as a variable,
the computer executes the second step more frequently than the first step, and
a part of the operation plan created in the first step is used as a constraint condition of the mathematical programming problem in the second step.

8. A non-transitory computer-readable storage medium storing a computer program that causes a computer to execute:
a first step of creating an operation plan for a hydrogen production facility in a first period in a future by solving a mathematical programming problem using an operation state of the hydrogen production facility for each time in the first period as a variable; and
a second step of creating an operation plan for the hydrogen production facility in a second period that is a future period shorter than the first period by solving a mathematical programming problem using an operation state of the hydrogen production facility for each time in the second period as a variable, wherein
the second step is executed more frequently than the first step, and
a part of the operation plan created in the first step is used as a constraint condition of the mathematical programming problem in the second step.
